(19) United States
(12) Patent Application Publication
(10) Pub. No.: US 2020/0364521 A1
(43) Pub. Date: Nov. 19, 2020

(54) TRAINED NETWORK FOR FIDUCIAL DETECTION

(71) Applicant: Matterport, Inc., Sunnyvale, CA (US)

(72) Inventors: Gary Bradski, Palo Alto, CA (US); Gholamreza Amayeh, San Jose, CA (US); Mona Fathollahi, Sunnyvale, CA (US); Ethan Rublee, Mountain View, CA (US); Grace Vesom, Woodside, CA (US); William Nguyen, Mountain View, CA (US)

(73) Assignee: Matterport, Inc., Sunnyvale, CA (US)

(21) Appl. No.: 16/412,765

(22) Filed: May 15, 2019

(51) Int. Cl. G06K 9/66; G06K 9/62; G06K 7/14

(52) U.S. Cl. CPC G06K 9/66; G06K 9/6246; G06K 7/1447; G06K 7/1417; G06K 9/6264

(57) ABSTRACT

Trained networks configured to detect fiducial elements in encodings of images and associated methods are disclosed. One method includes instantiating a trained network with a set of internal weights which encode information regarding a class of fiducial elements, applying an encoding of an image to the trained network where the image includes a fiducial element from the class of fiducial elements, generating an output of the trained network based on the set of internal weights of the network and the encoding of the image, and providing a position for at least one fiducial element in the image based on the output. Methods of training such networks are also disclosed.

### BACKGROUND

Fiducials elements are physical elements placed in the field of view of an imager for purposes of being used as a reference. Geometric information can be derived from images captured by the imager in which the fiducials are present. The fiducials can be attached to a rig around the imager itself such that they are always within the field of view of the imager or placed in a locale so that they are in the field of view of the imager when it is in certain positions within that locale. In the later case, multiple fiducials can be distributed throughout the locale so that fiducials can be within the field of view of the imager as its field of view is swept through the locale. The fiducials can be visible to the naked eye or designed to only be detected by a specialized sensor. Fiducial elements can be simple markings such as strips of tape or specialized markings with encoded information. Examples of fiducial tags with encoded information include AprilTags, QR Barcodes, Aztec, MaxiCode, Data Matrix and ArUco markers.

Fiducials can be used as references for robotic computer vision, image processing, and augmented reality applications. For example, once captured, the fiducials can serve as anchor points for allowing a computer vision system to glean additional information from a captured scene. In a specific example, available algorithms recognize an AprilTag in an image and can determine the pose and location of the tag from the image. If the tag has been “registered” with a locale such that the relative location of the tag in the locale is known a priori, then the derived information can be used to localize other elements in the locale or determine the pose and location of the imager that captured the image.

FIG. 1 shows a fiducial element 100 in detail. The tag holds geometric information in that the corner points 101-104 of the surrounding black square can be identified. Based on prior knowledge of the size of the tag, a computer vision system can take in an image of the tag from a given perspective, and the perspective can be derived therefrom. For example, a visible light camera 105 could capture an image of fiducial element 100 and determine a set of values 106 that include the relative position of four points corresponding to corner points 101-104. From these four points, a computer vision system could determine the perspective angle and distance between camera 105 and tag 100. If the position of tag 100 in a locale were registered, then the position of camera 105 in the locale could also be derived using values 106. Furthermore, the tag holds identity information in that the pattern of white and black squares serves as a two-dimensional bar code in which an identification of the tag, or other information, can be stored. Returning to the example of FIG. 1, the values 106 could include a registered identification “TagOne” for tag 100. As such, multiple registered tags distributed through a locale can allow a computer vision processing system to identify individual tags and determine the position of an imager in the locale even if some of the tags are temporarily occluded or are otherwise out of the field of view of the imager.

FIG. 1 further illustrates a subject 110 in a set 111 along with fiducial elements 112 and 113. There are systems and techniques available to segment, locate, and identify fiducial elements from images of the scene. These techniques include standard linearly-programmed computer vision algorithms which utilize edge detectors. The trusted performance of edge detectors, such as those used in these applications, is why traditional fiducial elements present so many sharp edges with strongly contrasting colors. While useful, traditional techniques suffer performance issues in terms of the time it takes to conduct the aforesaid actions, or the ability to perform the aforesaid actions at all when the fiducial element is not squarely presented towards an imager or is too far away. As a result, if an imager is at a wide angle from the face of a fiducial element, or the fiducial element is in the background of a locale, real time processing of the information content of the fiducial elements becomes difficult, if not impossible. With reference to imager 114 attempting to track subject 110 in locale 111, fiducial element 112 may be at too large of an angle relative to the imager to be detected while fiducial element 113 may be too far away. These problems are exacerbated when an imager is swept through a locale through the course of a scene while the fiducial elements are kept stationary as the angle and distance to the fiducial elements will accordingly vary.

### SUMMARY

This disclosure includes systems and methods for detecting fiducial elements in an image. The system can include a trained network. The network can be a directed graph function approximator with adjustable internal variables that affect the output generated from a given input. The network can be a deep net. The adjustable internal variables can be adjusted using back-propagation. The adjustable internal variables can also be adjusted using a supervised, semi-supervised, or unsupervised learning training routine. The adjustable internal variables can be adjusted using a supervised learning training routine comprising a large volume of training data in the form of paired training inputs and associated supervisors. The pairs of training inputs and associated supervisors can also be referred to as tagged training inputs. The networks can be artificial neural networks (ANNs) such as convolutional neural networks (CNNs). The disclosed methods include methods for training such networks.

The networks disclosed herein can take in an input in the form of an image and generate an output used to detect a fiducial element in the image. Detecting the fiducial element can include segmenting, locating, and identifying a fiducial element. Segmenting an object in an image generally refers to identifying the regions of the image associated with the object to the exclusion of its surroundings. Locating an object in an image generally refers to determining a position of the object. As used herein, determining the position of an object can refer to determining the point location of the object in space as well as determining a pose of the object in space. The location can be provided with reference to the image or with reference to a locale in which the object was located when the image was captured. The process of determining the position of a fiducial element can be referred to as localizing the fiducial element. Identifying a fiducial element can involve decoding an identification of the fiducial element that is encoded by the element.

FIG. 2 illustrates two views 200 and 210 of a subject in the form of a car 201 taken from different angles as an imager was swept around car 201. The subject includes fiducial elements fixed to the subject as well as a rigging suspended above the subject with fiducial elements in a stable location relative to the locale. Views 200 and 210 were subjected to processing using both traditional untrained computer vision algorithms and networks trained in accordance with this disclosure. In FIG. 2, fiducial elements surrounded by dotted-line circles indicate fiducial elements that were detected by the traditional algorithms. As seen in view 200, fiducial elements that are close to the imager 202, and a fiducial element that was square to the imager but at a moderate distance 203, were detected using traditional algorithms. At the same time, many fiducial elements 204 that were either too far away, or were not at the right angle, were not detected by the traditional algorithms. However, all these elements were detected, as shown by the darkened overlay, using a network in accordance with this disclosure. View 210 illustrates a similar outcome in which only two fiducial elements 211 that were quite close to the imager were detected using traditional algorithms, while many other fiducial elements 212 were detected using a network in accordance with this disclosure.

Locales in which the fiducial elements can be identified include a set, playing field, race track, stage, or any other locale in which an imager will operate to capture data in which fiducial elements may be located. The locale can include a subject to be captured by the imager along with the fiducial elements. The locale can host a scene that will play out in the locale and be captured by the imager along with the fiducial elements. The disclosed systems and methods can also be used to detect fiducials on a subject for an imager serving to follow that subject. For example, the fiducial could be on the clothes of a human subject, attached to the surface of a vehicular subject, or otherwise attached to a mobile or stationary subject.

Networks in accordance with this disclosure can be trained to detect fiducial elements from a particular class of fiducial elements. For example, a network can be trained to detect AprilTags while another network is trained to detect MaxiCode tags. However, networks in accordance with this disclosure can be trained to detect fiducial elements from a broader class of fiducial elements such as all two-dimensional encoded tags or all two-dimensional black-and-white edged-based encoded fiducial elements. Regardless, as the network has been trained to detect fiducial elements of a given class, it can be trained by a software distributor and delivered to a user in fully trained form. The trained network will therefore exhibit flexibility and performance benefits when compared to traditional computer vision approaches while not requiring any training by the end user. So long as the software distributor and software user agree regarding the class of fiducial elements the network is designed to detect, the network only needs to be trained by the distributor with that class of fiducials in mind and the system will recognize this benefit.

Networks in accordance with this disclosure can be part of a larger system used to detect the fiducial elements. For example, the output of a network can be a segmentation, localization, or identification of fiducial elements, but the network can also provide an output used by an alternative system to provide any of those data structures. The alternative system may be one or more untrained traditional computer vision algorithms. The division of labor between the network and traditional elements can take on various forms. For example, the network could be used to segment all two-dimensional black-and-white edge-based encoded fiducial elements from a scene, while a second system operated solely on those segmented encodings to identify the fiducial elements or determine their positions in the image. As another example, both the network and the alternative system could conduct the same actions and the information provided by each could be analyzed to provide a higher degree of confidence in the result of the combined system. In this sense, the networks disclosed herein can essentially boost the performance of more traditional methods of detecting fiducial elements. The boost in performance can lead to a decrease in the time required to detect fiducial elements and can in certain situations lead to the detection of fiducial elements that would not otherwise have been detected regardless of the time allotted. The performance boost can, in specific embodiments of the invention, allow for the real time segmentation, localization, and identification of fiducial images in a given image. For example, all three actions can be conducted as quickly as an imager can capture additional images in a stream of images for a live video stream.

In specific embodiments of the invention, a computerized method for detecting fiducial elements is provided. The method includes instantiating a trained network with a set of internal weights. The set of internal weights encode information regarding a class of fiducial elements. The method also includes applying an encoding of an image to the trained network. The method also includes generating an output of the trained network based on the set of internal weights of the network and the encoding of the image. The method also includes providing a position for at least one fiducial element based on the output. The at least one fiducial element is in the class of fiducial elements.

In specific embodiments of the invention, another computerized method for detecting fiducial elements is disclosed. The method includes instantiating a trained network for detecting a class of fiducial elements. The method includes applying an encoding of an image to the trained network and generating an output of the trained network based on the encoding of the image. The method also includes detecting a set of fiducial elements in the image based on the output. The set of fiducial elements are in the class of fiducial elements.

In specific embodiments of the invention, a computerized method for training a network for detecting fiducial elements is disclosed. The method includes synthesizing a training image with a fiducial element from a class of fiducial elements and synthesizing a supervisor for the training image that identifies the fiducial element in the training image. The method also includes applying an encoding of the training image to an input layer of the network and generating, in response to the applying of the training image, an output that identifies the fiducial element in the training image. The method also comprises updating the set of internal weights based on the supervisor and the output.

### BRIEF DESCRIPTION OF THE DRAWINGS

FIG. 1 is an illustration of a locale with fiducial elements in accordance with the related art.

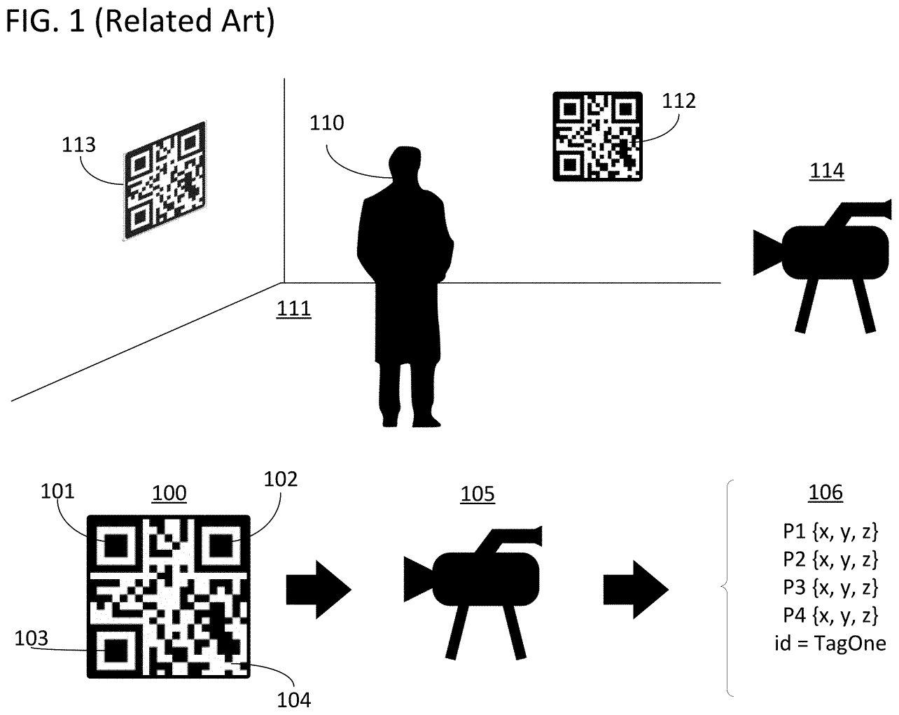

FIG. 2 includes two photographs of a subject with fiducial elements and overlaid labels to compare the performance of a traditional approach to identifying fiducial elements with the performance of a network in accordance with specific embodiments of the invention disclosed herein.

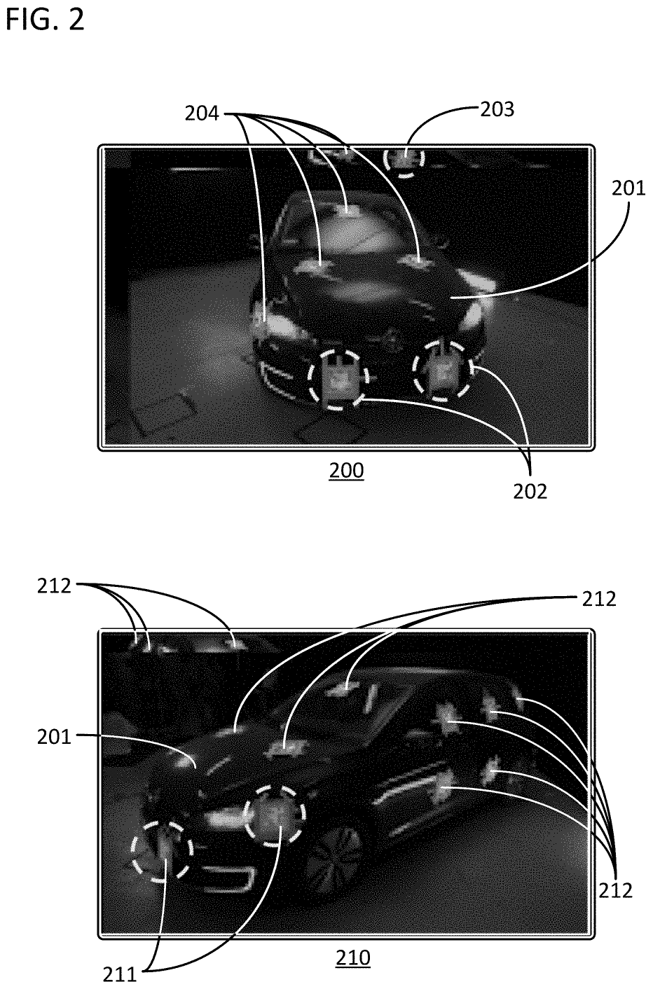

FIG. 3 is a flow chart for a set of computerized methods for detecting fiducial elements in accordance with specific embodiments of the invention disclosed herein.

FIG. 4 is a set of images that have been modified via compositing of fiducial elements to produce training data in accordance with specific embodiments of the invention disclosed herein.

FIG. 5 is a block diagram of a training data synthesizer along with a flow chart for a set of computerized methods for training a network in accordance with specific embodiments of the invention disclosed herein.

### DETAILED DESCRIPTION

Specific methods and systems associated with networks for detecting fiducial elements in accordance with the summary above are provided in this section. The methods and systems disclosed in this section are non-limiting embodiments of the invention, are provided for explanatory purposes only, and should not be used to constrict the full scope of the invention.

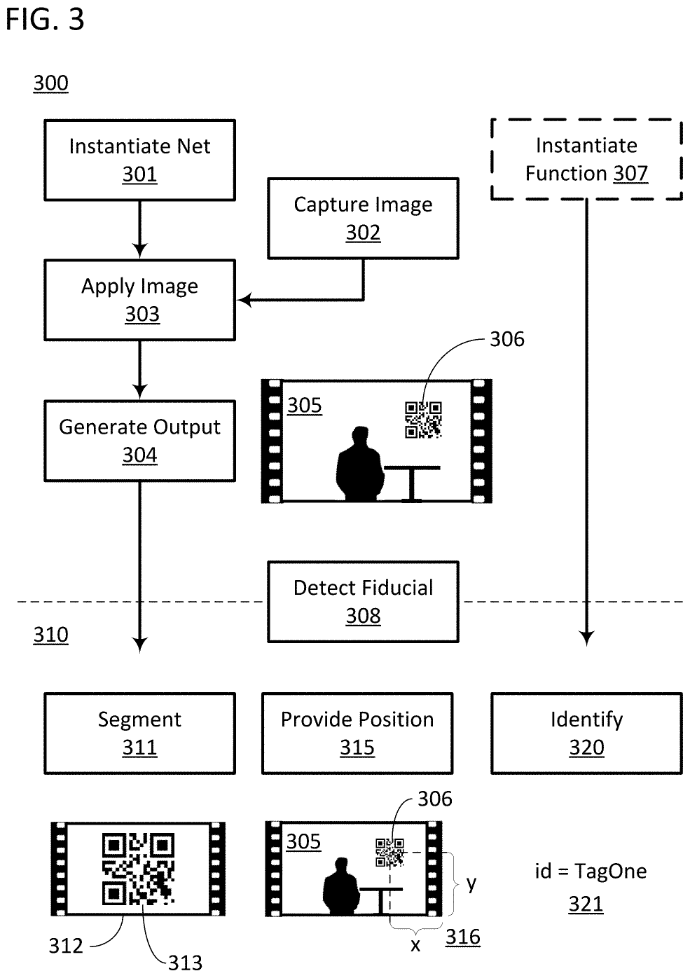

FIG. 3 includes flow chart 300 for a set of computerized methods for detecting fiducial elements. The flow chart begins with a step 301 of instantiating a network and a step 302 of capturing an image. The network can be a trained network for detecting fiducial elements in any image, such as the image captured in step 302. The network can be a network for detecting a specific class of fiducial elements. The network can be configured to detect all fiducial elements from that class of fiducial elements in an image applied to the network as an input. Either step 301 or step 302 can be conducted prior to the other since the network can operate on a series of stored images during post processing. However, one advantage of specific embodiments of the disclosed networks is their ability to detect fiducial elements in images in real time as the images are captured such that the network would first be instantiated and then the images would be captured.

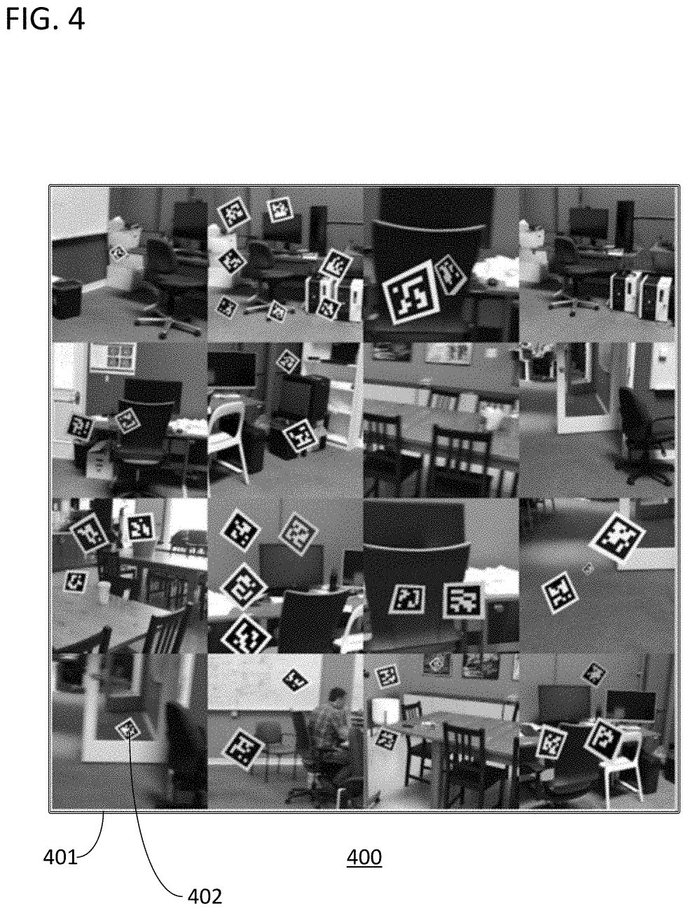

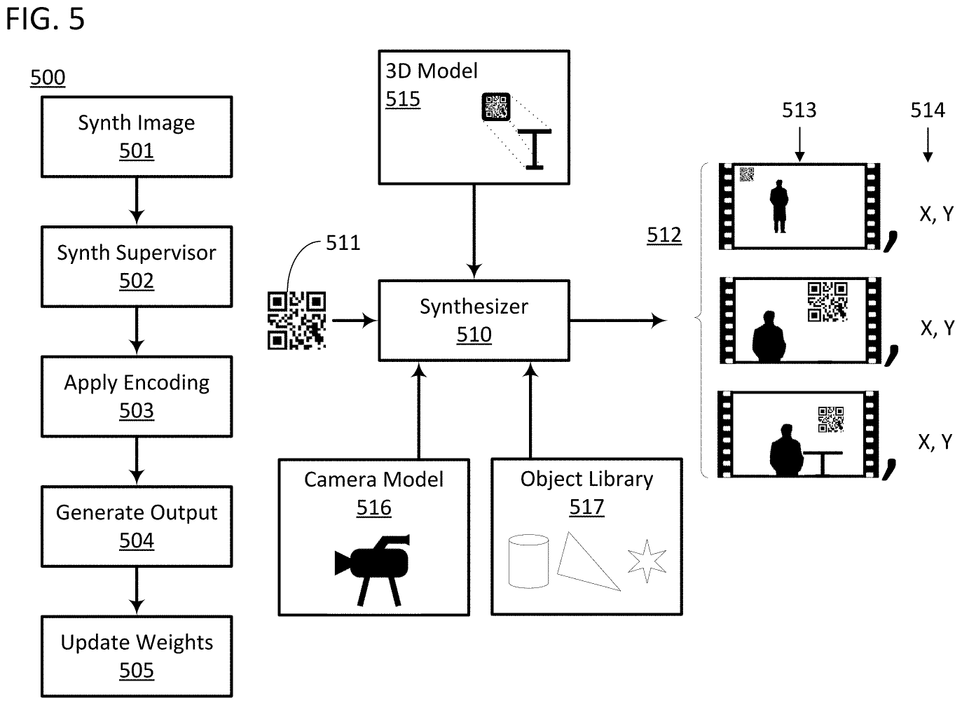

The network instantiated in step 301 can be a trained network. The network can be trained by a developer for a specific purpose. For example, a user could specify a class of fiducial elements for the network to identify and a developer could train a custom network to identify fiducial elements of that class. The network could furthermore be customized by being trained to work in a specific locale or type of locale, but this is not a limitation of the networks disclosed herein as they can be trained to detect fiducials of a specific class in any locale. In a specific embodiment, a developer could train specific networks for identifying common fiducial elements such as AprilTags or QR Code Tags and distribute them to users interested in detecting those fiducials in their images. As stated previously, the networks do not need to be so specialized and can be configured to detect a broader class of fiducials such as all two-dimensional encoded tags. In specific embodiments of the invention, the networks can be trained using the procedure described below with reference to FIGS. 4-5.

In specific embodiments of the invention, the networks can include a set of internal weights. The set of internal weights can encode information regarding a class of fiducial elements. The encoding can be developed through a training procedure which adjusts the set of internal weights based on information regarding the class of fiducial elements. The internal weights can be adjusted using any training routine used in machine learning applications including back-propagation with stochastic gradient descent. The internal weights can include the weights of multiple layers of fully connected layers in an ANN. If the network is a CNN or includes convolutional layers, the internal weights can include filter values for filters used in convolutions on input data or accumulated values internal to an execution of the network.

In specific embodiments of the invention, the networks can include an input layer that is configured to receive an encoding of an image. Those of ordinary skill in the art will recognize that a network configured to receive an encoding of image can generally receive any image of a given format regardless of the content. However, a specific network will generally be trained to receive images with a specific class of content in order to be effective.

The image the network is configured to receive will depend on the imager used to capture the image, or the manner in which the image was synthesized. The imager used to capture the image can be a single visible light camera, a depth sensor, or an ultraviolet or infrared sensor and optional projector. The imager can be a three-dimensional camera, a two-dimensional visible light camera, a dedicated depths sensor, or a stereo rig of two-dimensional imagers configured to capture depth information. The imager can include a single main camera such as a high-end hero camera and one or more auxiliary cameras such as witness cameras. The imager can also include an inertial motion unit (IMU), gyroscope, or other position tracker for purposes of capturing this information along with the images. Furthermore, certain approaches such as simultaneous localization and mapping (SLAM) can be used by the imager to localize itself as it captures the images.

The image can be a visible light image, an infrared or ultraviolet image, a depth image, or any other image containing information regarding the contours and or texture of a locale or object and fiducial elements located therein or thereon. In FIG. 3, the image 305 is a standard visible light image with a subject and a fiducial element 306 located in the image. The fiducial elements can accordingly be fiducials that are detectible by a visible light imager or by an infrared or ultraviolet imager. The fiducial elements can also be depth patterns that are detectible by a depth sensor. The fiducial element does not need to be detectible via visible light and can only be configured or positioned in the locale or subject to only be detected by a specialized non-visible-light sensor. The images can be two-dimensional visible light texture maps, 2.5-dimensional texture maps with depth values, or full three-dimensional point cloud images. The images can also be pure depth maps without texture information, surface maps, normal maps, or any other kind of image based on the application and the type of imager applied to capture the images. The images can also include appended position information regarding the position of the imager relative to a scene or object when the image was captured.

The encodings of the images can take on various formats depending on the image they encode. The encodings will generally be matrixes of pixel or voxel values. The encoding of the images can include at least one two-dimensional matrix of pixel values. The spectral information included in each image can accordingly be accounted for by adding additional dimensions or increasing said dimensions in an encoding. For example, the encoding could be an RGB-D encoding in which each pixel of the image includes an individual value for the three colors that comprise the texture content of the image and an additional value for the depth content of the pixel relative to the imager. The encodings can also include position information to describe the relative location and pose of the imager relative to a locale or subject at the time the image was captured.

In a specific embodiment of the invention, the capture could include a single still image of the locale or object, with an associated fiducial element, taken from a known pose. In more complex examples, the capture could involve the sweep of an imager through a location and the concurrent derivation or capture of the location and pose of the imager as the capture progresses. The pose and location of the imager can be derived using an internal locator such as an IMU or using image processing techniques such as self-locating with reference to natural features of the locale or with reference to pose information provided from fiducial elements in the scene. This pose and imagery captured by the imagers can be combined via photogrammetry to compute a three-dimensional texture mesh of the locale or object. Alternatively, the position of fiducial elements in the scene could be known a priori and knowledge of their relative locations could be used to determine the location and pose of other elements in the scene.

Flow chart 300 continues with a step 303 of applying an encoding of an image to the network instantiated in step 301. The network and image can have any of the characteristics described above. The network can be configured to receive an encoding of an image. In specific embodiments of the invention, an input layer of the network can be configured to receive an encoding in the sense that the network will be able to process the input and deliver an output in response thereto. The input layer can be configured to receive the encoding in the sense that the first layer of operations conducted by the network can be mathematical operations with input variables of a number equivalent to the number of variables that encode the encodings. For example, the first layer of operations could be a filter multiply operation with a 5-element by 5-element matrix of integer values with a stride of 5, four lateral strides, and four vertical strides. In this case, the input layer would be configured to receive a 20-pixel by 20-pixel grey scale encoding of an image. However, this is a simplified example and those of ordinary skill in the art will recognize that the first layer of operations in a network, such as a deep-CNN, can be far more complex and deal with much larger data structures by many orders of magnitude. Furthermore, a single encoding may be broken into segments that are individually delivered to the first layer via a pre-processing step. Additional pre-processing may be conducted on the encoding before it is applied to the first layer such as converting the element data structures from floating point to integer values etc.

Flow chart 300 continues with a step 304 of generating an output of the trained network based on the encoding of the image. The output can also be based on a set of internal weights of the network. The output can be generated by executing the network using the encoding of the image as an input. The execution can be targeted towards detecting specific fiducial elements of a given class based on the fact that the internal weights were trained and selected to detect fiducial elements of that class. The output can take on various forms depending on the application. In one example, the output will include at least one set of x any y coordinates for the position of a fiducial element in an input image. The output can be provided on an output node of the network. The output node could be linked to a set of nodes in a hidden layer of the network, and conduct a mathematical operation on the values delivered from those nodes in combination with a subset of the internal weights in order to generate two values for the x and y coordinates of the fiducial element in an image delivered to the network, or a probability that a predetermined location in the image is occupied by a fiducial element. As stated, previously, the output of the trained network could include numerous values associated with multiple fiducial elements in the image.

The format of the output produced can vary depending upon the application. In particular, the output could either be a detection of the fiducial element itself, or it could be an output that is utilized by an alternative system to detect the fiducial elements. The alternative system could be a traditional untrained linearly-programmed function. As such, flow chart 300 includes an optional step 307 of instantiating an untrained scripted function. The untrained scripted function could be a commonly available image processing function programmed using linear programming steps in an object-oriented programming language. The untrained scripted function could be an image processing algorithm embodied in source code and configured to be instantiated using a processor and a memory. This step is optional because, again, the output of the network could itself be a detection of the fiducial element. Instantiating the function could include initializing the function in memory such that is was available to operate on the output of the network in order to detect fiducial elements in the image. The output could be a position of the object, a segmentation of the object, an identity of the object, or an output that enables a separate function to provide any of those. The output could be a modified version of the input image. Furthermore, the output could include an occlusion flag or flags to indicate that one or more of the fiducial elements was occluded in an image. For example, the network could identify when an encoded fiducial element is in the image but is partially occluded such that it cannot be decoded etc. The network could encode information regarding an expected set of fiducial elements in order to determine when specific fiducial elements are fully occluded. In the case of a fiducial element located on an object, the output could also or alternatively include a self-occluding flag to indicate that the fiducial element is occluded in the image by the object itself. The flag could be a bit in a specific location with a state specifically associated with occlusion such that a “1” value indicated occlusion and a “0” value indicated no occlusion. In these embodiments, the output could also include a coordinate value for the location in the image associated with the fiducial element even if it is occluded. The coordinate value could describe where in the image the fiducial element would appear if not for the occlusion. Occlusion indicators can provide important information to alternative image processing systems, such as the function instantiated in step 307, since those systems will be alerted to the fact that a visual search of the image will not find the tracked point and time and processing resources that would otherwise be spent conducting such searches can be thereby by saved.

Flow chart 300 continues with a step 308 of detecting one or more fiducial elements in the image. The step can include detecting a set of fiducial elements in the image based on the output generated in step 304. The step can be conducted by the network alone or by the network in combination with the function instantiated in step 307. Various breakdowns of tasks between the network and the function instantiated in step 307 are possible. The division of labor can be decided based on the availability of certain functions for processing images with standard fiducial elements, such as identifying the encoding or determining the pose of the fiducial element upon determining the corner locations of the fiducial element. The network can be tasked with conducting actions that traditional functions are slow at doing such as detecting and segmenting tags that are at large angles or distances relative to the imager. The network can also be tasked with providing information to the function that would increase the performance of the function, for example delivering an occlusion flag to the function greatly improve its performance since the system will know not to continue an ever more precise search routine to search for a specific element if it is already known that the element is not in the image.

Step 308 can include providing a position for at least one fiducial element based on the output of the network. This step is illustrated by step 315 in FIG. 3. The step can be conducted entirely by the network such that the output of the network is the position. Alternatively, the step can be conducted by the network and function such that the output is used indirectly to determine the position. Regardless, the position will be determined based on the output of the network. The act of providing the position can include providing the position of one or every fiducial element in a given image. The position can be a location or pose. The location can be provided with respect to the image, such as the x and y coordinates 316 in a two-dimensional image. The location can also be provided with respect to the locale in which the image was captured such as a set of three-dimensional coordinates in a frame of reference defined by the locale without reference to the image. The position can also be a set of three-dimensional coordinates for a fiducial element in a three-dimensional image. The position can also be a specific description of a pose of one or every fiducial element in three-dimensional space. The location can alternatively be provided with respect to a three-dimensional environment in which the fiducial was located. The location can also be an area occupied by the fiducial element. The area can be defined with respect to the locale in which the image was taken or with respect to an area defined by pixels on the image. For example, the network could identify all pixel values in an image that include fiducial elements by forming a data structure with the same number of entries as there are pixels in the image and provide a one or a zero in each cell in which a fiducial element was detected. Those of ordinary skill in the art will realize that the resulting data structure may serve as a hard mask for the fiducial elements in the image such that locating the position and segmenting the image overlap in this regard. The act of providing the position can include providing the position of one or every fiducial element of a given class in a given image. In specific embodiments, the hard mask values can be modified such that the “1” values can be substituted with values that identify the specific tag that occupies a given pixel or voxel.

Step 308 can include a step 311 of segmenting one or every fiducial element from a given class in an image. The output of the network could be a segmentation of one or more fiducial elements in the image from the remainder of the image. The fiducial elements could be located in the same place in the image, but with the remainder of the image set to a fixed value such as values associated with translucency, or a solid color such as white or black. The segmentation could also reformat the one or more fiducial elements such that they were each positioned square to the face of the image. Those of ordinary skill in the art will recognize the overlap of an execution of step 315 in which the position is the area occupied by the fiducial element or elements in the image and an execution of step 311 in which each element is segmented but is otherwise kept in its original spatial position within the image.

In specific embodiments of the invention, the output of the network executing step 311 could be a hard mask of the fiducial element or elements provided with reference to the pixel of voxel map of the image. However, the segmenting could also include translating or rotating the fiducial elements in space to present them square to the surface of the image. Each detected fiducial element could be laid out in order in a single image or be placed in its own image encoding. For example, fiducial element 306 has been segmented in image 312 and set square to the surface of the image to provide a new image 313 which may be easy for a second system to use to identify the fiducial element. The image generated in the execution of step 311 could be a grid of tags neatly aligned and prepared for further processing.

In specific embodiments of the invention, the network will segment or otherwise identify the fiducial elements in the image, and traditional untrained scripted functions can be used to detect the fiducial elements. The functions could be one or more functions instantiated in step 307. The detecting of the fiducial elements by these functions could include deriving pose, location, and identification information from each fiducial element in a set of fiducial elements using the segmentation, or other identification, of the fiducial elements in the image as provided by the network.

There are numerous possible implementations of the process described in the prior paragraph. For example, the output of the network could be an original image with only the fiducial elements exposed while the remainder of the image is blacked out to allow a traditional untrained scripted function to focus only on the images of the tags. As another example, the output could be the fiducial elements translated towards the imager to increase the efficacy of the identifying system. In either situation, the availability of occlusion indicators would additionally render the collection of this information more efficient as the traditional untrained scripted functions would ignore the position of the occluded fiducial elements based on the occlusion indicator, and not continue to search for the occluded fiducial element. As another example, the network could take a rough cut at segmenting or otherwise detecting the fiducial elements, and the traditional untrained scripted function can be used to determine the pose of the tag. For example, the network could determine the distance between the four corners of an AprilTag and a traditional system, with knowledge of the ArpilTag's size, could determine the pose of the AprilTag in the image. These embodiments are both beneficial in that there are commonly available closed-form functions for this problem, and the solutions provided by these functions would be difficult to train for in terms of the size of the network and training set required to do so.

Step 308 can include a step 320 of identifying the fiducial image. In the illustrated case, identifying the fiducial element involves processing the encoding on the fiducial to determine that the fiducial is “TagOne” 321. The network can be configured and trained to produce an ID from an image of the fiducial element, or it can be configured to segment and deliver a translated image of the tag to an untrained scripted function that is programmed to decode and read the encoding of the fiducial element.

In specific embodiments of the invention, multiple functions can be instantiated in step 307 where each specializes in a separate task. Each of the tasks can utilize one or more of the outputs generated by the network in step 304. For example, the network can provide a segmentation of the fiducial elements or identify a location of the fiducial elements while one function operates on those outputs to identify the fiducial elements and another operates to determine the pose of the fiducial elements.

In specific embodiments of the invention, the network and one or more associated functions could cooperate to conduct a global bundle adjustment of a set of position estimates. The position estimates could be the output generated by the network or based on the output of the network after a first step of post processing with an untrained scripted function. In other words, the providing in step 315 could provide a bundle of position values for a set of fiducial elements. The global bundle adjustment of the position estimates could be conducted to more accurately identify the position of each fiducial. In particular, if the relative positions of the fiducial elements was known a priori, detection and identification of the fiducial elements in the image could be utilized with this information to iteratively solve for the location of the tag relative to the image at a level of accuracy unavailable to the imager itself such as one that is immune from imager nonidealities and sub-pixel effects. The a priori knowledge of the relative position of the fiducial elements could be a three-dimensional model of the fiducial elements determined through physical measurement or using photogrammetry operating on a collection of images of the location. The building of the model could be conducted on an ongoing basis as the network was used to analyze images of the scene such that the system would increase in accuracy as time progressed.

In specific embodiments of the invention, the network and one or more associated functions could cooperate to conduct an iterative improvement of the position determination. As stated, the precise position of a fiducial element could be mistakenly determined due to imager nonidealities, sub-pixel effects, and other factors. Therefore, the first iteration of step 315 (e.g., the position provided by the network) can be referred to as a position estimate as opposed to the ground truth position of the fiducial element in the image. The iterative convergence of the position estimate could be guided by the untrained scripted function instantiated in step 307. The untrained scripted function could be a best match search routine. The untrained scripted function could be a cost function minimization routine wherein the cost function was based on the current position estimate from an iteration of step 315 and the actual position of the fiducial element in the image.

In specific embodiments of the invention, the cost function can rely on the difference between the image of the fiducial element from the original image and a model of the fiducial element which has been warped to match the current position determination. For example, in a first iteration, the model of the fiducial element could be warped to the position determined by the network. The system would then have available to it: an image of the fiducial element from the original image, and a model of the fiducial element that has been warped to approximately the same position (e.g., pose) as in that image. The cost function could then be based on the original image of the fiducial element and the warped model of the fiducial element, and minimizing the cost function could involve fitting the warped model of the fiducial element to the fiducial element as it appears in the image. The cost function can be based on various quantities such as the normalized cross correlation between the image of the fiducial element from the original image and the warped model of the fiducial element. The values used to calculate the cross correlation could be the corresponding pixel or voxel values in the original image that correspond to the fiducial element and in the warped model. If the image of the fiducial element were two dimensional, the warped model could be rendered in two-dimensions for this purpose. In these embodiments, a perfect match would produce a “1” and a perfect mismatch would produce a “−1”. The cost function could therefore be (1−normalized_cross_correlation [pose warped clean fiducial model, fiducial element image from original image]). Minimizing the cost function by finding the ideal fit would drive this function to zero.

In a specific example of the process described in the preceding paragraph, step 304 could include producing a variant of the image in which only the fiducial elements were visible and all else was removed. Next, the function instantiated in step 307 could determine the likely pose of the fiducial elements given the information from the network. Next, the function could add modified clean images of the fiducial elements, modified so that their pose matches the pose determined for them by the network, to a blank. The function could also identify the specific fiducial elements for this purpose (i.e., identifying the specific fiducial element would assure the correct model was used). Any form of iterative approach such as one using normalized cross correlation could then be used to compare the image with only the fiducial elements and the synthesized image with the modified clean images added to iteratively improve the accuracy of the pose estimate for the one or more fiducial elements.

FIG. 5 illustrates a flow chart 500 for a set of computerized methods for training a network for detecting fiducial elements in accordance with specific embodiments of the present invention. The figure also includes an accompanying data flow diagram for the operation of a training data synthesizer 510. The synthesizer can generate training images for the training data. The synthesizer can generate stored images and composite fiducial elements onto the stored images. Alternatively, the synthesizer can operate on a set of stored images in a library and simply composite fiducial elements onto the stored images. The synthesizer can also control the generation of three-dimensional models for generating training images as described below. In doing any of these actions, the synthesizer can also generate a supervisor in the form needed to train the network. The form of the supervisor will vary depending upon what the network is being trained to do. For example, the supervisor could be a set of coordinates for a point location or area in the image associated with the fiducial element. In another example, the supervisor could be an identity of the fiducial element. In another example, the supervisor could be the pose of the fiducial element in a training image. The supervisor will in effect be the answer that the network is trained to provide in response to its associated training image.

A large volume of training data should be generated in order to ultimately train a network to identify fiducial elements in an arbitrary image. The data synthesizer 510 can be used to synthesize a large volume of data as the process for generating the data will be conducted purely in the digital realm. The synthesizer can be augmented with the ability to vary the lighting, shadow, or noise content of stored images, training images, and/or the composited fiducial elements, in order to increase the diversity of the training data set and to match randomly generated or selected fiducial elements with random images in which they are composited. Furthermore, the synthesizer may include access to three-dimensional models of various locales, an object library, and rendering software capable of compositing objects with fiducial elements added thereto into three dimensional locales. The synthesizer could then render two dimensional images from the three-dimensional models. The synthesizer could use a graphics rendering toolbox and/or OpenGL code for this purpose. The synthesizer could include access to a camera model 516 for rendering or otherwise generating training images from a given pose. The camera model could be stochastic to increase the diversity of the training set, or modified to match that of an imager with which the network will be utilized. A developer could receive this model from or furnish this model for a user. The pose of the virtual imager used to render the two-dimensional images could be stochastically selected in order to increase the diversity of the training data set. Furthermore, the training data synthesizer may have the ability to generate new three-dimensional models of various locales and draw from the different models when generating a training image to further increase the diversity of the training data set.

The synthesizer can be configured to generate both the training images and their associated supervisors. The supervisor fiducial element location can be a location in the training image where the tracking point is located. FIG. 5 includes three pairs of training data generated in this fashion 512. Each of these pairs of training data include a training image 513 and associated supervisor 514 in the form of a set of x and y coordinates corresponding to the location of the fiducial element the image. In situations in which the images are being rendered from a three-dimensional model obtaining the supervisor is nearly trivial in that the system must know the position of the fiducial for the very fact that it placed the fiducial itself. In situations in which the images are being rendered from an incomplete model or from a store of training images, information regarding the locale from which the image was taken can be used to attach locale position information from the perspective of an imager associated with the training image to the supervisor. The locale position information can be known from a priori physical measurement of the locale and extracted from the training image prior to compositing using standard computer vision algorithms. The a priori physical measurement can include the provisioning of a three-dimensional model of at least a portion of the locale.

Flow chart 500 includes step 501 of synthesizing a training image with a fiducial element from a class of fiducial elements and step 502 of synthesizing a supervisor for the training image that identifies the fiducial element in the training image. The fiducial element class can be selected by a user and serve as the impetus for an entire training routine. For example, a user may decide to train the network to identify two-dimensional encoded tags, and thereby select that as the class to serve as the basis for the training data set. In the figure, this selection is shown by element 511 being provided to data synthesizer 510. An automatic system can be designed to generate a large volume of fiducial elements of that class to be composited. The system can be a random number generator working in combination with an AprilTag or QR Code generator. However, the system can also be designed to stochastically generate fiducials of a greater variety based on the class definition provided by a user.

The step of synthesizing the training image can include stochastically compositing a fiducial element onto an image. The image can be a stored image drawn from a library or synthesized as part of step 501. In FIG. 5, synthesizer 510 can generate synthesized training images by rendering images from three-dimensional model 515. The three-dimensional model can be used to synthesize a training image in that a random camera pose could be selected from within the model and a view of the three-dimensional model from that pose could be rendered to serve as the training image. The process can be conducted through the user of camera model 516. The process can be conducted using a graphics rendering toolbox and/or OpenGL code. The model could be a six degrees-of-freedom (6-DOF) model for this purpose. A 6-DOF model is one that allows for the generation of images of the physical space with 6-DOF camera pose flexibility, meaning images of the physical space can be generated from a perspective set by any coordinate in three-dimensional space: (x, y, z), and any camera orientation set by three factors that determine the orientation of the camera: pan, tilt, and yaw. The three-dimensional model can also be used to synthesize a supervisor tracking point location. The supervisor tracking point location can be the coordinates of a tracking point in a given image. The coordinates could be x and y coordinates of the pixels in a two-dimensional image. In specific embodiments, the training image and the tracking point location will both be generated by the three-dimensional model such that the synthesized coordinates are coordinates in the synthesized image.

In specific embodiments of the invention, the model itself can be designed to vary during the generation of a training data set. For example, each time synthesizer 510 generates a new training image, it can utilize a different three-dimensional model of a different scene. As another example, virtual objects from an object library 517 could be stochastically added to the model in order to modify it. The fiducial elements could be composited onto the random shapes pulled from the object library 517 and rendered along with the objects in the scene using standard rendering software. In specific embodiments of the invention, a set of fixed positions will be defined in a set of images for receiving randomly generated or selected fiducial elements. The fiducial elements are then applied to these fixed positions to composite the fiducial elements into the image. After the fiducial elements have been applied to the model, random two-dimensional images can be rendered therefrom by selecting an imager pose. Alternatively, two dimensional images can be generated with similar fixed positions for the fiducial elements to be added. However, these approaches require image processing to warp the fiducial element onto the fixed position appropriately while in the case of adding the fiducials to three dimensional images the warping is conducted naturally via the rendering software used to render two dimensional images from the model. Approaches in which fixed positions are identified allow a large volume of training images or models to be generated ahead of time so that multiple users can composite selected classes of fiducial elements into the prepared training images or models to train their own networks for a specific class of fiducial elements. In other words, the set of models or images with fixed positions for fiducial elements to be added can be reused for training different networks.

In specific embodiments of the invention, the object library 517 and three-dimensional model 515 can be specified according to a user's specifications. Three-dimensional meshes in the form of OBJ files can be applied to the object library or used to build the three-dimensional model portion of the system. The meshes can be specified with specific textures as selected by the users. The users may also be able to select from a set of potential three-dimensional surfaces to add such as planes, boxes, or conical objects.

In specific embodiments of the invention, training images can also be synthesized via compositing of occlusions into the images to occlude any fiducial elements that remain in the locale or object and also occlude the fiducial element itself. As such, step 501 can be conducted to include stochastically occluding the fiducial element in the training image. The occluding objects can be random geometric shapes or shapes that are likely to occlude the fiducials when the network is deployed at run time. For example, a cheering crowd shape could be used in the case of a stage performance locale, sports players in the case of a sports field locale, or actors on a set in a live stage performance. The supervisor tracking point in these situations can also include a supervisor occlusion indicator such that the network can learn to identify when a specific fiducial element is occluded by people and props that are introduced in and around the fiducial element. In a similar way, the training data can include images in which a fiducial with an encoding is self-occluded (e.g., the view of the imager is from the back side of a fiducial and the code is on the front). The network can be designed to throw a separate self-occlusion flag to indicate this occurrence. As such, the step of synthesizing training data can include synthesizing a self-occlusion supervisor so the network can learn to determine when a fiducial element is self-occluded.

Once the training data is synthesized it can be applied to train the network. Flow chart 500 continues with a step 503 of applying an encoding of a training image to an input layer of the network. Step 503 is subsequently followed by a step 504 of generating, in response to the applying of the training image, an output that identifies the fiducial element in the training image. The output generated in step 504 can then be compared with the supervisor as part of a training routine to update the internal weights of the network in a step 505. For example, the output and supervisor can be provided to a loss function whose minimization is the objective of the training routine that adjusts the internal weights of the network. Batches of prepared training data can be applied to train networks for deployment in trained form. The batches can also include fixed positions for adding fiducial elements so that they can be quickly repurposed for training a network to identify fiducial elements of different classes.

While the specification has been described in detail with respect to specific embodiments of the invention, it will be appreciated that those skilled in the art, upon attaining an understanding of the foregoing, may readily conceive of alterations to, variations of, and equivalents to these embodiments. While the example of a visible light camera was used throughout this disclosure to describe how an image is captured, any sensor can function in its place to capture an image including depth sensors without any visible light capture in accordance with specific embodiments of the invention. While language associated with ANNs was used throughout this disclosure any trainable function approximator can be used in place of the disclosed networks including support vector machines and other function approximators known in the art. Any of the method steps discussed above can be conducted by a processor operating with a computer-readable non-transitory medium storing instructions for those method steps. The computer-readable medium may be memory within a personal user device or a network accessible memory. Modifications and variations to the present invention may be practiced by those skilled in the art, without departing from the scope of the present invention, which is more particularly set forth in the appended claims.

What is claimed is:

1. A computerized method for detecting fiducial elements, the method comprising:
instantiating a trained network with a set of internal weights, wherein the set of internal weights encode information regarding a class of fiducial elements;
applying an encoding of an image to the trained network;
generating an output of the trained network based on: (i) the set of internal weights of the trained network; and (ii) the encoding of the image; and
providing a position for at least one fiducial element based on the output of the trained network, wherein the at least one fiducial element is in the class of fiducial elements.

2. The computerized method for detecting fiducial elements of claim 1, wherein:
the class of fiducial elements is two-dimensional coded tags; and
the information encoded by the set of internal weights is information regarding a training set of synthesized images with composited two-dimensional coded tags.

3. The computerized method for detecting fiducial elements of claim 1, wherein:
the information encoded by the set of internal weights is information regarding a training set of synthesized images with composited fiducial elements from the class of fiducial elements; and
the training set of synthesized images are rendered from a three-dimensional model.

4. The computerized method for detecting fiducial elements of claim 1, further comprising:
receiving a definition of the class of fiducial elements;
compositing a set of fiducial element image into a set of synthesized training images;
training the trained network using the set of synthesized training images;
wherein information encoded by the set of internal weights is a set of synthesized training images with composited fiducial elements.

5. The computerized method for detecting fiducial elements of claim 4, wherein the compositing further comprises:
applying the fiducial element onto a fixed position in the training set of synthesized images;
wherein the training set of synthesized images are generated using a three-dimensional model; and
wherein the applying is conducted using information from the three-dimensional model regarding the fixed position.

6. The computerized method for detecting fiducial elements of claim 1, wherein the position is one of:
a pose of the fiducial element;
a location of the fiducial element; and
an area occupied by the fiducial element in the image.

7. The computerized method for detecting fiducial elements of claim 1, wherein:
the providing is executed by an output layer of the trained network;
the providing is for a bundle of position values for a set of fiducial elements including the at least one fiducial element.

8. The computerized method for detecting fiducial elements of claim 7, further comprising:
instantiating an untrained scripted function;
conducting a global bundle adjustment of a bundle of position estimates for the set of fiducial elements using the bundle of position values; and
wherein the conducting is executed by the untrained scripted function.

9. The computerized method for detecting fiducial elements of claim 1, further comprising:
warping a fiducial element model using the position;
comparing the warped fiducial element model to the fiducial element as it appears in the image using a normalized cross correlation calculation; and
conducting an adjustment of the position using data from the comparing step.

10. The computerized method for detecting fiducial elements of claim 1, further comprising:
warping a fiducial element model using the position;
conducting an iterative adjustment of the position using a cost function; and
wherein the cost function is based on the warped fiducial element model and the fiducial element as it appears in the image.

11. The computerized method for detecting fiducial elements of claim 1, wherein:
the position is an area occupied by the fiducial element in the image; and
the providing involves segmenting a set of fiducial elements from the image.

12. The computerized method for detecting fiducial elements of claim 11, further comprising:
instantiating an untrained scripted function;
deriving pose, location, and identification information from each fiducial element in the set of fiducial elements using the untrained scripted function and the segmented set of fiducial elements.

13. The computerized method for detecting fiducial elements of claim 1, further comprising:
providing an occlusion indicator for the fiducial element based on the output.

14. The computerized method for detecting fiducial elements of claim 13, the method further comprising:
instantiating an untrained scripted function;
conducting a global bundle adjustment of a bundle of position estimates for the set of fiducial elements;
wherein the global bundle adjustment ignores the position based on the occlusion indicator; and
wherein the conducting is executed by the untrained scripted function.

15. A computerized method for detecting fiducial elements, the method comprising:
instantiating a trained network for detecting a class of fiducial elements;
applying an encoding of an image to the trained network;
generating an output of the trained network based on the encoding of the image;
detecting a set of fiducial elements in the image based on the output; and
wherein each fiducial element in the set of fiducial elements is in the class of fiducial elements.

16. The computerized method for detecting fiducial elements of claim 15, wherein:
the class of fiducial elements is two-dimensional coded tags; and
the detecting of the set of fiducial elements includes: (i) processing the two-dimensional encoding of each fiducial element; (ii) segmenting each fiducial element; and (iii) determining a position of each fiducial element.

17. The computerized method for detecting fiducial elements of claim 15, further comprising:
receiving a definition of the class of fiducial elements;
compositing a fiducial element image into a training set of synthesized images; and
training the trained network using the training set of synthesized images.

18. The computerized method for detecting fiducial elements of claim 15, further comprising:
applying the fiducial element onto a fixed position in a training set of synthesized images;
wherein the training set of synthesized images are generated using a three-dimensional model; and
wherein the applying is conducted using information from the three-dimensional model regarding the fixed position.

19. The computerized method for detecting fiducial elements of claim 15, further comprising:
warping a fiducial element model using the position;
conducting an iterative adjustment of the position using a cost function; and
wherein the cost function is based on the warped fiducial element model and the fiducial element as it appears in the image.

20. A computerized method for training a network for detecting fiducial elements, the method comprising:
synthesizing a training image with a fiducial element from a class of fiducial elements;
synthesizing a supervisor for the training image that identifies the fiducial element in the training image;
applying an encoding of the training image to an input layer of the network;
generating, in response to the applying of the training image, an output that identifies the fiducial element in the training image; and
updating the network based on the supervisor and the output.

21. The computerized method of claim 20, further comprising:
generating a three-dimensional model;
synthesizing the training image includes: (i) stochastically compositing the fiducial element into the three-dimensional model; and (ii) rendering, after compositing the fiducial element, the training image from the three-dimensional model.

22. The computerized method of claim 20, wherein:
the class of fiducial elements are two-dimensional encoded tags; and
synthesizing the training image includes stochastically compositing a two-dimensional encoded tag onto a stored image.

23. The computerized method of claim 20, wherein:
the class of fiducial elements are registered fiducials; and
synthesizing the training image includes compositing a fiducial element onto a fixed location.

24. The computerized method of claim 23, further comprising:
generating a three-dimensional model;
stochastically adding a virtual object into the three-dimensional model;
defining the fixed location with respect to the three-dimensional model; and
rendering, after adding the virtual object and compositing the fiducial element, the training image from the three-dimensional model.

25. The computerized method of claim 20, wherein:
the network is trained for a locale;
synthesizing the training image includes attaching locale position information for a perspective of an imager associated with the training image.

26. The computerized method of claim 20, wherein:
synthesizing the training image includes stochastically occluding the fiducial element in the training image.
